(19) United States
(12) Patent Application Publication
(10) Pub. No.: US 2015/0374458 A1
(43) Pub. Date: Dec. 31, 2015

(54) ENDODONTIC TOOL WITH ROTATIONAL AND AXIAL RECIPROCATION

(71) Applicant: Ghassan YARED, Toronto (CA)

(72) Inventor: Ghassan YARED, Toronto (CA)

(21) Appl. No.: 14/652,418

(22) PCT Filed: Dec. 11, 2013
(86) PCT No.: PCT/CA2013/001018

§ 371 Date: Jun. 15, 2015

(30) Foreign Application Priority Data
Dec. 13, 2012 (CA) 2799718

(51) Int. Cl. A61C 5/02; A61C 1/18; A61C 3/02

(52) U.S. Cl. CPC A61C 5/023; A61C 3/02; A61C 1/188

(57) ABSTRACT

A hand-held tool for moving an endodontic instrument is provided, for preparing a root canal for filling. The tool comprises a chuck for holding the instrument, a rotational driver mechanism for rotating the chuck alternately in forward and reverse directions, and an axial driver mechanism for reciprocating the chuck axially.

### FIELD OF THE INVENTION

This invention relates to endodontic tools, in particular reciprocating tools for performing endodontic procedures such as root canal treatments and retreatments.

### BACKGROUND OF THE INVENTION

An important endodontic procedure, known as a “root canal” procedure, involves removing organic material from the root canals of an infected tooth and filling the canal with an inert obturating material such as gutta percha gum.

An effective root canal procedure avoids extraction of the infected tooth. In this procedure, a dentist or endodontist utilizes a series of endodontic instruments, for example files, for the debridement, cleaning and sterilization of the root canal. These files are rotated within the canal to clean the canal surfaces, removing debridement (organic) material in the process, facilitating improved irrigation, and in some cases shaping the canal for easier filling with the obturating material.

While this procedure used to be done manually, engine-driven (for example motor-driven) rotary tools are now available for providing the rotational motion necessary for the effective debridement and cleaning of the root canal, One of the problems with such tools, however, is that the rotational force is not completely within the control of the dentist or endodontist, Files used for debridement and removal of organic material work like augers, moving material out of the root canal via a helical groove. This effectively makes the file behave like a screw, driving forward when rotated in the forward direction (which may for example, depending upon the orientation of the threads, be the counter-clockwise direction) and backing off when rotated in the reverse (for example clockwise) direction, However, the threads defining the helical groove can lock or catch on interior canal surfaces, especially in constricted and/or curved parts of the canal. If too much force is applied to the file at such points the file can break, necessitating removal of the broken piece of file which can be a difficult procedure which could ultimately result in extraction of the tooth, effectively obviating the benefit of the root canal procedure.

Accordingly, a motor-driven tool has been developed which rotates through a defined arc in a “forward” direction which drives the file into the canal and a defined (typically lesser) are of rotation in the “reverse” direction which backs the file out of the canal. This reduces opportunities for the file to lock or catch on the inner surfaces of the canal, while effectively debriding, cleaning and shaping the root canal for filling. An example of such a tool is described in U.S. Pat. No. 6,293,795 issued Sep. 25, 2001 to Johnson, which is incorporated herein by reference.

An instrument such as a file used in a canal for debridement will be subjected to stress in the form of torsion (torque). This will cause the structure of the file material, for example metal or plastic, to undergo changes. These changes can be reversible or irreversible, depending on the amount of torque to which the instrument is subjected during the canal debridement. In U.S. Pat. No. 6,293,795 the torque set on the motor may be higher than the elastic limit of the file; also, the arcs of rotation in the forward and reverse directions may subject the tool to torque greater than the elastic limit of the file. Therefore, any changes in the material will be irreversible.

Thus, in the tool described in U.S. Pat. No. 6,293,795, if the instrument locks at a point where a torque higher than the failure point of the particular file is being applied, the file can break in the root canal. If the instrument locks at a point where a torque higher than the elastic limit of the file is being applied, initially a non-visible alteration of the metal structure will occur, and at a higher torque distortion or visible deformation of the file will occur, particularly at a point in the procedure where the debriding file is bending through a curve in the canal. If a debriding file is reused, material fatigue through successive uses can be cumulative, increasing the likelihood of plastic distortion or breaking of the file.

The root canal procedure can be as effectively accomplished using a reciprocating endodontic hand tool such as that described in U.S. Pat. No. 6,293,795, but in which the torque applied to the debriding file does not exceed the elastic limit of the file, which occurs at about 170 degrees for many commonly used files such as NiTi. This makes the root canal procedure far safer, considerably reducing the possibilities of plastic distortion and fatigue, or breakage of the file during the canal debriding/cleaning/shaping process. A method and device for this procedure is described and illustrated in U.S. Publication No. 20120225406 filed Sep. 6, 2012 by Yared, which is incorporated herein by reference.

It has further been discovered that the root canal procedure can be as effectively accomplished, and in some cases where the canal anatomy is complex more effectively accomplished, using a reciprocating endodontic hand tool such as that described in U.S. Pat. No. 6,293,795, but in which the torque applied to the debriding file does not exceed the endurance limit of the file, which occurs at about 10 degrees, or the durability limit of the file, which occurs at about 20 degrees, as described and illustrated in co-pending PCT Application No. PCT/CA2013/000757 filed Sep. 5, 2013 by Yared, which is incorporated herein by reference.

The continuous advancement of the file in the canal may lead to screwing or locking of the instrument in the canal. Removing a locked file may be difficult and time-consuming depending on the length of the file that screwed in the canal; it can also lead to other complications such as perforating the root of the tooth. In addition, the file may fracture in the canal during the removal procedure. Those complications can adversely affect the outcome of the root canal treatment. To minimize the incidence of file screwing or locking in the canal, it is recommended to manipulate the instrument in an axial “pecking” procedure as noted by Varela-Patino et al. (2008), which is incorporated herein by reference, with a length of axial reciprocation of approximately 3-4 mm. In addition, it is recommended that the file be removed completely out of the canal after 3 ‘pecks’. However, inexperienced dentists may still lock the file in the canal inadvertently, mainly in narrow and curved canals.

Also, one of the most challenging steps in the canal preparation is to find the canal path and to establish the patency of the canal with small files to ensure that the larger files will be able to safely prepare the canal. This is typically accomplished with small hand files used with very small left and right rotations and with very small axial in- and out-movements. In narrow and curved canals, the files used for this purpose are at an increased risk of fracture; these files can also lead to iatrogenic errors (Berutti et al. 2009, West 2011).

Particularly in the case of a complex canal anatomy, frequently the practitioner must bend the tip of the instrument and carefully manipulate the tool back and forth as the instrument reciprocates, in order to allow the instrument to ‘find’ the direction of the canal for further penetration. This part of the procedure requires a delicate touch, but even the most skilled practitioner cannot accurately coordinate their hand motion with the instrument reciprocation, which can detract from the ability of the instrument to find the canal. Because forward rotation of the instrument tends to drive the instrument further into the canal, while the reverse rotation tends to back the instrument out of the canal, the practitioner's hand motion can actually oppose the natural tendency of the instrument to penetrate into and recede from the canal merely through its rotary reciprocation motion.

### BRIEF DESCRIPTION OF THE DRAWINGS

In drawings which illustrate by way of example only a preferred embodiment of the invention,

FIG. 1 is a schematic illustration of a tool according to the invention.

FIG. 2 is a cross-section of the head of the tool of FIG. 1 showing the instrument in an axially extended position.

FIG. 3 is a cross-section of the head of the tool of FIG. 1 showing the instrument in an axially retracted position.

### DETAILED DESCRIPTION OF THE INVENTION

The invention provides a tool capable of both rotary and axial reciprocation. In the preferred embodiments the parameters of the tool may be set as desired to coordinate axial and rotary reciprocation to achieve the best results in a particular procedure. It will be appreciated that not every advantage referred to herein applies to every embodiment of the invention.

The invention thus provides a hand-held tool for moving an endodontic instrument for preparing a root canal for filling in a root canal procedure, the tool comprising a handle, a chuck for holding the instrument, a rotational driver mechanism for rotating the chuck, an axial driver mechanism for reciprocating the chuck axially, and a controller for controlling a rotational motion of the chuck in forward and reverse directions and for controlling an axial reciprocation of the chuck, such that the instrument can cut the canal, remove debridement material and advance in the canal.

The invention further provides a method of moving an endodontic instrument in a hand-held tool for preparing a root canal for filling in a root canal procedure, the tool comprising a handle, a chuck for holding the instrument, a rotary driver mechanism for rotating the chuck, and an axial driver mechanism for reciprocating the chuck axially, the method comprising, in any order, the steps of: a. setting at least one torque limit for rotating the chuck, whereby the instrument can cut the canal, remove debridement material and advance in the canal, b. setting and axial limit for reciprocating the chuck axially, and c. activating the tool.

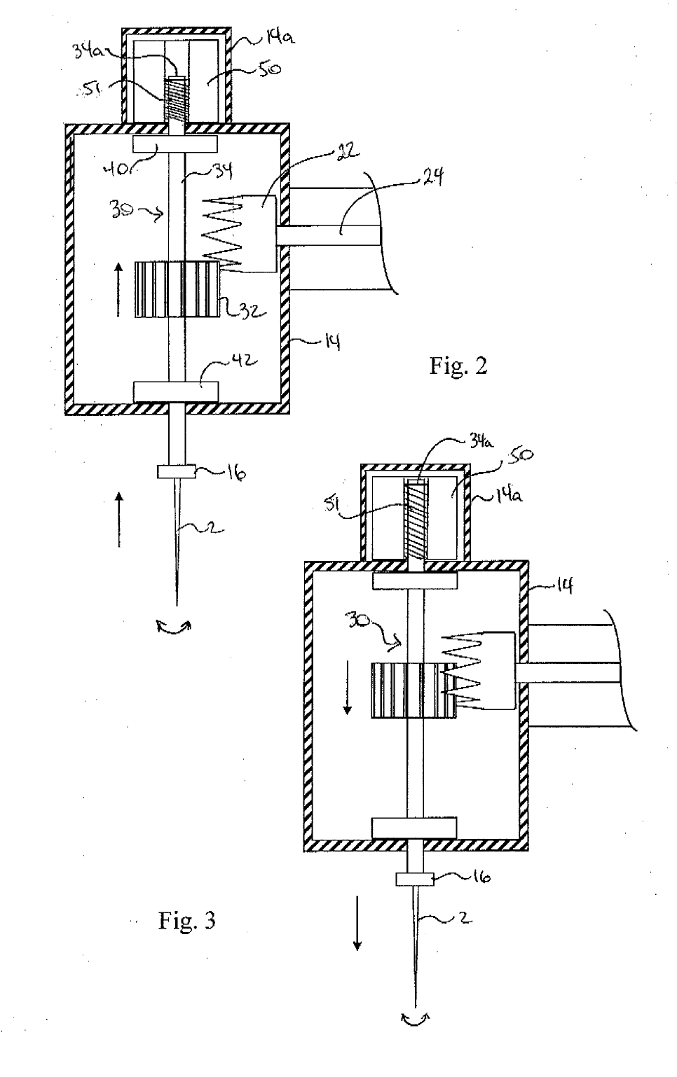

An endodontic tool 10 according to the invention comprises a handle 12 supporting a head 14 containing a rotor 30, illustrated in FIGS. 2 and 3. A chuck 16 or other attachment means for inserting an instrument 2, such as a debriding file or similar endodontic instrument, is affixed to the rotor 30.

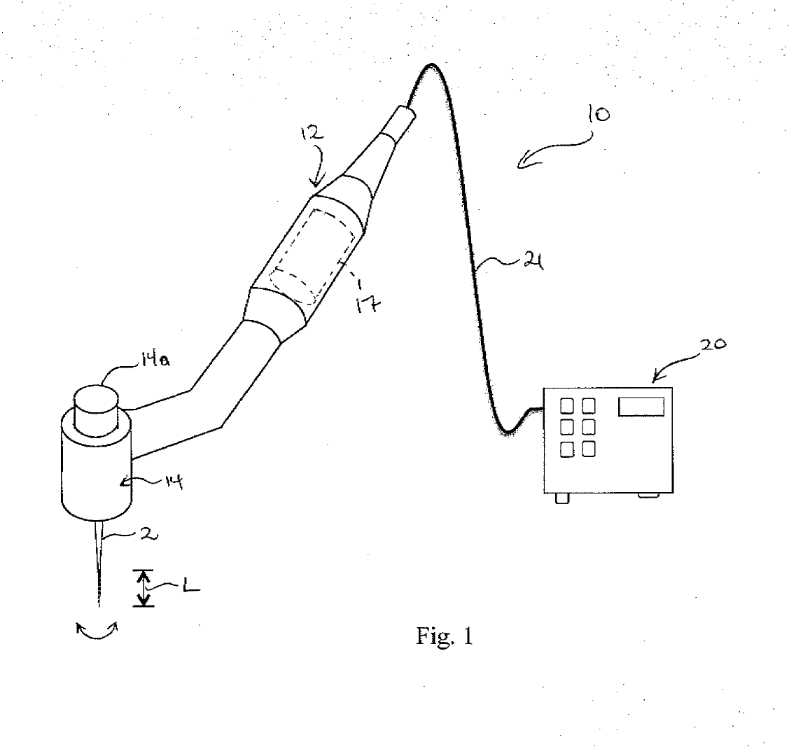

In the table-top version of the tool illustrated in FIG. 1, the handle 12 contains a rotational driver mechanism comprising a motor 17 controlled and powered via a power supply cord 21 attached to a control module 20. The motor 17 drives the chuck 16 via a gear train 18 disposed within the head 14. In the embodiment shown the motor 17 is an electric motor connected by a cable to a control module 20, which provides means for setting the parameters of the tool 10 mechanically or, preferably, via a microprocessor.

The control module 20 provides controls for the user of the tool 10 to set such rotational parameters as the speed, arc of rotation, torque and others, for example as described in U.S. Pat. No. 6,293,795 which is incorporated herein by reference. In addition, the control module 20 provides means for controlling axial reciprocation of the rotor 30 and thus the instrument 2, as will be described in greater detail below.

A microprocessor in the control module 20 receives data from the user input into the control module user interface 20a to set one or more of the desired parameters for the forward and reverse arcs of rotation 4a, 4b of the rotary reciprocating motion, a torque limit at which the motor 17 will cease rotating in the current direction, and the rotational speed of the rotor 30 (which may differ in the forward and reverse directions). In the preferred embodiment of the invention, without limitation, the maximum amount of torque to be applied to the debriding file 2 in the forward and the reverse rotary directions is set so as not to exceed the endurance limit or durability of the specific instrument 2 being used, which may vary according to the composition and configuration of the instrument 2, as is more fully described in co-pending PCT Application No. PCT/CA2013/000757 filed Sep. 5, 2013 by Yared, which is incorporated herein by reference. Thus, in the preferred embodiment the preset forward and reverse arcs of rotation 4a, 4b should not normally subject the instrument 2 to a torque (torsional stress) higher than the endurance limit or durability limit of the specific file 2 being used; however, it is open to exceed these limits in specific situations, particularly in the case of a simple canal anatomy.

In the embodiment illustrated the rotational driver mechanism further comprises a drive train, in the embodiment shown a crown gear 22 rotationally affixed to a gear shaft 24, which is rotationally affixed to the motor 17. The crown gear 22 meshes with a rotor gear 32 that is rotationally and axially affixed to the rotor shaft 34. The rotor shaft 34 is radially fixed between a rear bearing 40 and a front bearing 42, within which the rotor shaft 34 can both rotate freely and slide axially. The control module 20 thus controls the motor 17 to rotate the crown gear 22 and thus the rotor 30, in both directions, through any desired arc of rotation and at any desired speed. The rotor 30 in turn rotates the chuck 16, and thereby rotates the instrument 2.

An axial driver mechanism is provided to reciprocate the instrument 2 axially, preferably independently of the rotary reciprocation provided by the rotational driver mechanism. The free end 34a of the rotor shaft 34 is contained within a solenoid coil 50, contained within a housing extension 14a. The rotor shaft is preferably made of iron, or the free end 34a is provided with iron or another a magnetic material or a permanent magnet, which effectively turns the rotor shaft 34 into a solenoid plunger. Thus, when the control module 20 energizes the solenoid coil 50, the entire rotor shaft 30 is moved axially as shown in FIG. 2. A spring 52 biases the rotor 30 to the retracted position shown in FIG. 3 when the solenoid coil 50 is quiescent.

In the preferred embodiment the axial motion of the rotor shaft 30 has an upper limit L, as shown in FIG. 1, of about 10 mm; however this can be selected as desired as long as the rotor gear 32 is made tall enough that the crown gear 22 meshes with the rotor gear 32 in all axial positions of the rotor 30. In the preferred embodiments the axial reciprocation will normally be between 2 and 4 mm, with a preferred maximum of about 5 mm.

The axial speed of and force applied by the rotor 30 as it moves to the extended position shown in FIG. 2 is determined by the strength (power) of the electrical signal sent to the solenoid coil 50, increasing as the power increases. The length of the stroke of the rotor 30 as it moves to the extended position is determined by the duration of the signal sent to the solenoid coil 50, increasing as the signal duration increases. As some variability in stroke length can be expected based on signal duration alone, if desired mechanical means such as a set screw or the like (not shown) can be built into the head 14 to adjust the maximum stroke length in cases where precision is particularly required.

In some embodiments a torque sensor (not shown) is provided to set a maximum torque during rotation, and the control module 20 is programmed to cut or reduce the signal to the motor 17 if the maximum torque is exceeded. Also, In some embodiments a force sensor, for example a load cell (not shown), is provided to set a maximum force during axial extension, and the control module 20 is programmed to cut or reduce the strength of the signal to the solenoid coil 50 if the maximum axial force is exceeded. Angles of rotation and the axial advancing force of the instrument can be advantageously automatically changed between the endurance limit and the elastic limit in certain situations. For example, in case of an abrupt canal curvature the force sensor would detect the increased resistance against axial motion when the tip of the instrument 2 hits the canal wall, and the control module 20 can automatically switch to durability limit angles of about 20 degrees (or other angles as desired) and low force/shorter stroke axial motion to find the canal. Similarly, when the canal direction is located the force sensor would detect the sudden decreased resistance to axial motion, and the control module 20 can automatically switch to endurance limit angles of about 10 degrees (or other angles as desired) and higher force/longer stroke axial motion to continue advancing the instrument 2 in the canal.

In one preferred embodiment the forward stroke, extending the rotor 30 out of the head 14 as shown in FIG. 2, coincides with a forward rotation of the instrument 2, and the reverse stroke, retracting the rotor 30 back into the head 14 as shown in FIG. 3, coincides with a reverse rotation of the instrument 2. In this embodiment the practitioner can hold the tool 10 relatively steadily while the combination of the forward axial motion of the instrument 2 and the driving motion of the instrument's rotation, in the forward direction advances the instrument 2 deeper into the canal.

The tool of the invention is particular useful in the case of a complex canal anatomy. In a manual procedure, once the instrument hits the wall of the canal the tip of the instrument 2 would be bent by the practitioner and the instrument 2 manually rotated while applying a slight forward pressure, until the tip finds the canal opening at which point the debridement process continues as the practitioner continues to advance the instrument 2 in the canal. Utilizing the tool 10 of the invention, in this situation the practitioner can hold the tool 10 essentially still while the combination of the forward axial pressure of the instrument 2 during axial reciprocation and the rotary motion of the instrument, changing the rotational orientation of the bent tip, will assist in finding the direction of the canal. In these situations the instrument 2 is preferably rotated at a very low speed and may axially reciprocate multiple times during a single arc of rotation, allowing the tip of the instrument 2 time to find the direction of the canal.

There are many combinations and permutations available for timing axial reciprocation and rotary reciprocation (in both directions), torque applied by the motor 17, and stroke length, speed and force. There may also be advantages to using rotational or axial reciprocation alone at certain points in a root canal procedure. If there is a ledge, the combination of both rotational and axial movements will allow the file to ‘find’ the path of the canal, but at that point the use of only axial reciprocation at very low amplitudes (2 mm for example) will allow the practitioner to dampen or eliminate the ledge, which will make it easier to find the canal path after the file is removed to irrigate the canal. It may be advantageous in some cases to use rotational reciprocation alone at the beginning of the root canal enlargement in cases where the canal is very narrow due to calcification at its coronal orifice; the file will be more efficient in entering the canal using only rotational reciprocation because axial reciprocation in these specific cases will reduce the cutting ability and the forward movement of the file into the narrow calcified canal orifice.

This combined movement could potential be useful in tele-dentistry, i.e. remote dentistry applications, as part of a “robotic treatment” controlled by a practitioner from a different location, for example where the patient is in a remote area, at sea or in outer space.

Various embodiments of the present invention having been thus described in detail by way of example, it will be apparent to those skilled in the art that variations and modifications may be made without departing from the invention. The invention includes all such variations and modifications as fall within the scope of the appended claims.

1. A hand-held tool for moving an endodontic instrument for preparing a root canal for filling in a root canal procedure, the tool comprising
a handle,
a chuck for holding the instrument,
a rotational driver mechanism for rotating the chuck,
an axial driver mechanism for reciprocating the chuck axially, and
a controller for controlling a rotational motion of the chuck in forward and reverse directions and for controlling an axial reciprocation of the chuck,
such that the instrument can cut the canal, remove debridement material and advance in the canal.

2. The tool of claim 1 wherein the controller is programmed to rotate the rotor alternately in forward and reverse directions during at least a portion of the root canal procedure.

3. The tool of claim 2 wherein the axial driver mechanism reciprocates the chuck axially independently of rotation by the rotational driver mechanism.

4. The tool of claim 2 wherein the controller rotates the chuck in the reverse direction when a torque on the instrument during forward rotation reaches a preset limit.

5. The tool of claim 4 wherein the preset limit is an elastic limit of the instrument.

6. The tool of claim 2 wherein when a torque on the instrument during forward rotation reaches a preset limit the controller reduces an angle of rotation of the chuck.

7. The tool of claim 6 wherein the preset limit is an elastic limit of the instrument.

8. The tool of claim 6 wherein the angle of rotation in at least one direction is reduced to an endurance limit of the instrument which occurs at about 10 degrees or durability limit of the instrument which occurs at about 20 degrees.

9. The tool of claim 2 wherein the controller rotates the instrument in a forward direction when the axial driver mechanism extends the instrument from the handle.

10. The tool of claim 2 wherein axial reciprocation has a limit of about 5 mm.

11. A method of moving an endodontic instrument in a hand-held tool for preparing a root canal for filling in a root canal procedure, the tool comprising a handle, a chuck for holding the instrument, a rotary driver mechanism for rotating the chuck, and an axial driver mechanism for reciprocating the chuck axially, the method comprising, in any order, the steps of:
a. setting at least one torque limit for rotating the chuck, whereby the instrument can cut the canal, remove debridement material and advance in the canal,
b. setting and axial limit for reciprocating the chuck axially, and
c. activating the tool.

12. The method of claim 11 wherein the chuck is rotated alternately in forward and reverse directions during at least a portion of the root canal procedure.

13. The method of claim 12 wherein the chuck is reciprocated axially independently of rotation of the chuck.

14. The method of claim 12 comprising, after step c., the step of rotating the chuck in the reverse direction when a torque on the instrument during forward rotation reaches a preset limit.

15. The method of claim 14 wherein the preset limit is an elastic limit of the instrument.

16. The method of claim 12 comprising, after step c., the step of reducing an angle of rotation of the chuck when a torque on the instrument during forward rotation reaches a preset limit.

17. The method of claim 16 wherein the preset limit is an elastic limit of the instrument.

18. The method of claim 16 wherein the angle of rotation in at least one direction is reduced to an endurance limit of the instrument which occurs at about 10 degrees or durability limit of the instrument occurring at about 20 degrees.

19. The method of claim 12 wherein the instrument is rotated in a forward direction when the axial driver mechanism extends the instrument from the handle.

20. The method of claim 12 wherein axial reciprocation has a limit of about 5 mm.
